(19) United States
(12) Patent Application Publication
(10) Pub. No.: US 2016/0277985 A1
(43) Pub. Date: Sep. 22, 2016

(54) NETWORK HANDOVER METHOD, AND TERMINAL

(71) Applicant: HUAWEL TECHNOLOGIES CO., LTD., Shenzhen (CN)

(72) Inventor: Shucheng YU, Shanghai (CN)

(21) Appl. No.: 15/034,574

(22) PCT Filed: Jun. 23, 2014
(86) PCT No.: PCT/CN2014/080538

§ 371 Date: May 5, 2016

(51) Int. Cl. H04W 36/16; H04W 48/18

(52) U.S. Cl. CPC H04W 36/16; H04W 48/18; H04W 88/06

(57) ABSTRACT

A network handover method, and a terminal are provided. The method includes: receiving an operation instruction for disabling a data service, and handing over, according to the operation instruction for disabling a data service, a second network currently used by the terminal to a first network; or receiving an operation instruction for enabling a data service, and handing over, according to the operation instruction for enabling a data service, a first network currently used by the terminal to a second network, where a network standard of the first network is a Universal Mobile Telecommunications System UMTS network standard or a Global System for Mobile Communications GSM network standard, and a network standard of the second network is a Long Term Evolution LTE network standard.

### TECHNICAL FIELD

The present invention relates to the communications field, and in particular, to a network handover method, and a terminal.

### BACKGROUND

The circuit switched fallback (Circuit Switched Fall Back, CSFB) technology is a technology in which a Long Term Evolution (Long Term Evolution, LTE) terminal uses a voice service by means of a circuit switched domain. A piece of User equipment (User Equipment, UE) often camps on an LTE network, and uses a data service provided by the LTE network. When initiating a voice call or receiving a voice call, the UE can fall back to a 2G/3G circuit switched domain network for the voice call, and then hand over to the LTE network after the voice call ends.

A voice of the CSFB technology-based LTE network is implemented by a Global System for Mobile Communications/Universal Mobile Telecommunications System (Global System for Mobile Communication/Universal Mobile Telecommunications System, GU, that is, 2G/3G) network. Therefore, only a high-speed data service can be used in the LTE network, and the long-term camping of the UE on the LTE network leads to great waste of LTE network resources.

### SUMMARY

Embodiments of the present invention provide a network handover method and a terminal, so that when UE needs to perform a packet switched data service, a handover to a high-speed data network is implemented, which saves high-speed data network resources.

According to a first aspect, an embodiment of the present invention provides a network handover method, applied to a terminal, where the method includes:

receiving an operation instruction for disabling a data service, and handing over, according to the operation instruction for disabling a data service, a second network currently used by the terminal to a first network; or

receiving an operation instruction for enabling a data service, and handing over, according to the operation instruction for enabling a data service, a first network currently used by the terminal to a second network, where

a network standard of the first network is a UMTS network standard or a GSM network standard, and a network standard of the second network is an LTE network standard.

According to the first aspect, in a first possible implementation manner, before the receiving an operation instruction for disabling a data service, the method further includes: attaching the terminal to the second network.

According to the first aspect or the first possible implementation manner of the first aspect, in a second possible implementation manner, the handing over a second network currently used by the terminal to a first network specifically includes: sending a detach Detach request to a network side device of the second network, so that the terminal is detached from the second network; and sending an attach Attach request to a network side device of the first network, so that the terminal is attached to the first network.

According to the first aspect or the first or second possible implementation manner of the first aspect, in a third possible implementation manner, the handing over a first network currently used by the terminal to a second network specifically includes: sending a routing area update RAU request to the network side device of the second network; and after the network side device receives the routing area update request, reselecting and camping on an idle-state cell of the second network, so that the terminal hands over back to the second network through reselection.

According to a second aspect, an embodiment of the present invention provides a terminal, where the terminal includes a receiving unit, and a first handover unit or a second handover unit, where

the receiving unit is configured to receive an operation instruction for disabling a data service; and

the first handover unit is configured to hand over, according to the operation instruction for disabling a data service, a second network currently used by the terminal to a first network; or

the receiving unit is further configured to receive an operation instruction for enabling a data service; and

the second handover unit is configured to hand over, according to the operation instruction for enabling a data service, a first network currently used by the terminal to a second network, where

a network standard of the first network is a UMTS network standard or a GSM network standard, and a network standard of the second network is an LTE network standard.

In a first possible implementation manner, the terminal further includes: an attaching unit, configured to attach the terminal to the second network.

According to the second aspect or the first possible implementation manner of the second aspect, in a second possible implementation manner, a process of handing over, by the first handover unit, a second network currently used by the terminal to a first network is specifically: sending a detach Detach request to a network side device of the second network, so that the terminal is detached from the second network; and sending an attach Attach request to a network side device of the first network, so that the terminal is attached to the first network.

According to the second aspect or the first or second possible implementation manner of the second aspect, in a third possible implementation manner, a process of handing over, by the second handover unit, a first network currently used by the terminal to a second network is specifically: sending a routing area update RAU request to the network side device of the second network; and after the network side device receives the routing area update request, reselecting and camping on an idle-state cell of the second network, so that the terminal hands over back to the second network through reselection.

According to a third aspect, an embodiment of the present invention further provides a terminal, where the terminal includes a network interface and a processor, and the network interface and the processor are connected by using a bus, where

the network interface is configured to receive an operation instruction for disabling a data service; and the processor is configured to hand over, according to the operation instruction for disabling a data service, a second network currently used by the terminal to a first network; or

the network interface is further configured to receive an operation instruction for enabling a data service; and

the processor is configured to hand over, according to the operation instruction for enabling a data service, a first network currently used by the terminal to a second network, where

a network standard of the first network is a UMTS network standard or a GSM network standard, and a network standard of the second network is an LTE network standard.

In a first possible implementation manner, before the network interface receives the operation instruction for disabling a data service, the processor is further configured to: attach the terminal to the second network.

According to the third aspect or the first possible implementation manner of the third aspect, in a second possible implementation manner, the handing over, by the processor, a second network currently used by the terminal to a first network specifically includes: sending a detach Detach request to a network side device of the second network, so that the terminal is detached from the second network; and sending an attach Attach request to a network side device of the first network, so that the terminal is attached to the first network.

According to the third aspect or the first or second possible implementation manner of the third aspect, in a third possible implementation manner, the handing over, by the processor, a first network currently used by the terminal to a second network specifically includes: sending a routing area update RAU request to the network side device of the second network; and after the network side device receives the routing area update request, reselecting and camping on an idle-state cell of the second network, so that the terminal hands over back to the second network through reselection.

In the network handover method, and the terminal that are provided by the embodiments of the present invention, the terminal receives an operation instruction for disabling a data service, and hands over, according to the operation instruction for disabling a data service, a second network currently used by the terminal to a first network; or receives an operation instruction for enabling a data service, and hands over, according to the operation instruction for enabling a data service, a first network currently used by the terminal to a second network, where a network standard of the first network is a UMTS network standard or a GSM network standard, and a network standard of the second network is an LTE network standard. Therefore, in the present invention, when UE disables a data service and does not use a high-speed data network, an automatic handover to the first network is performed and the terminal may use a service provided by the first network. When the UE needs to perform a packet switched data service, a handover of a network standard to the second network is performed, so that the terminal hands over between the first network and the second network, thereby reducing network resources of the high-speed data network.

### BRIEF DESCRIPTION OF DRAWINGS

FIG. 1 is a flowchart of a network handover method according to an embodiment of the present invention;

FIG. 2 is a schematic diagram of a terminal according to an embodiment of the present invention; and

FIG. 3 is a schematic diagram of another terminal according to an embodiment of the present invention.

### DESCRIPTION OF EMBODIMENTS

The technical solutions of the present invention are further described in detail with reference to accompanying drawings and embodiments as follows:

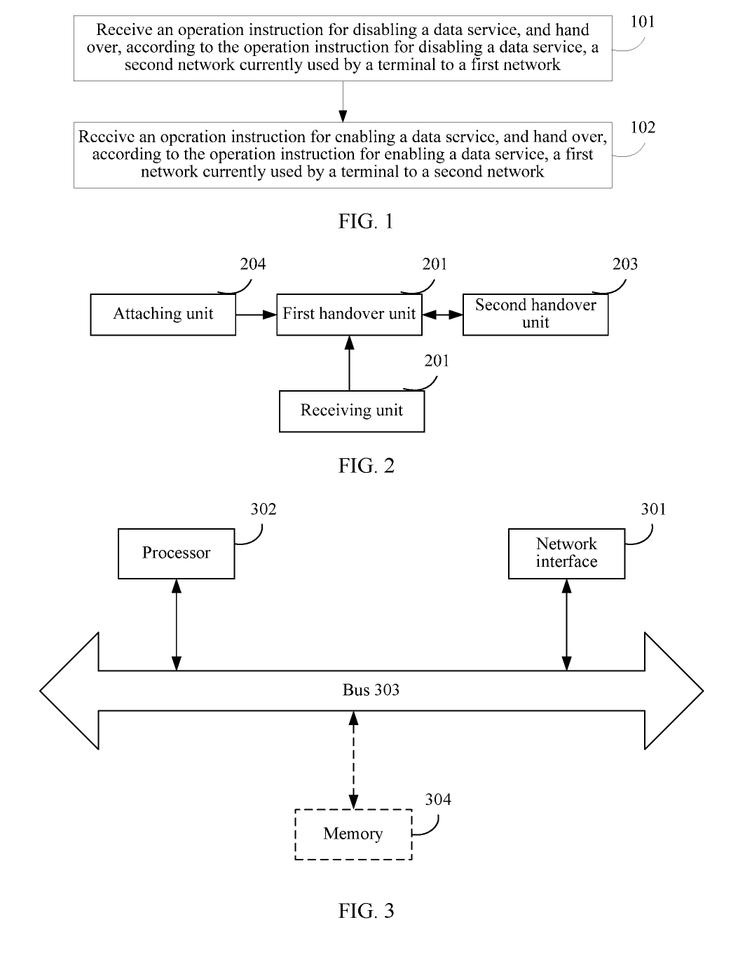

FIG. 1 is a flowchart of a network handover method according to an embodiment of the present invention. This embodiment is executed by a terminal. This embodiment describes in detail a process in which after a terminal currently camping on a second network receives an operation instruction, from a user, for disabling a data service, the terminal hands over the network currently used by the terminal to a first network, and describes a process in which after the terminal receives an operation instruction for enabling a data service, the terminal is re-handed over to the second network. As shown in FIG. 1, this embodiment includes the following steps:

Step 101: Receive an operation instruction for disabling a data service, and handover, according to the operation instruction for disabling a data service, a second network currently used by the terminal to a first network.

In this embodiment of the present invention, after the terminal is turned on in an area covered by LTE, the terminal performs network selection and camps on an LTE network.

When a user does not need to perform a packet switched (Packet Switch, PS) service, a data service of the terminal may be disabled by means of a touch operation or a click operation. When determining that the operation instruction, from the user, for disabling a data service is received, the terminal first performs an operation of deactivating a Packet Data Protocol (Packet Data Protocol, PDP) context, so as to release LTE wireless resources. After releasing the LTE wireless resources, the terminal hands over the originally used second network (such as a network of an LTE network standard) to the first network (such as a network of a 2G/3G network standard).

A network standard of the first network is a GSM network standard or a UMTS network standard, and a network standard of the second network is an LTE network standard.

Specifically, the handing over a network currently used by the terminal to a first network specifically includes: sending a detach Detach request to a network side device of the second network, so that the terminal is detached from the second network; and sending an attach Attach request to a network side device of the first network, so that the terminal is attached to the first network.

Both a process of performing a detach Detach operation between the terminal and the LTE network side and a process of performing an attach Attach operation between the terminal and the 2G/3G network side belong to the prior art. This embodiment of the present invention does not specifically limit the processes, and details are not described herein.

When the user does not need a high-speed data service, the data service may be disabled by means of the operation in step 101, and an automatic handover to the 2G/3G network is performed. In this way, the terminal may use a circuit switched (Circuit Switched, CS) service provided by the 2G/3G network. When the terminal receives a voice call during this period, the terminal may enjoy call connection experience that is the same as that of 2G/3G networks. Generally, a user of a smart terminal disables a data service when the user does not use the data service. Therefore, this operation can effectively improve the call connection experience.

Step 102: Receive an operation instruction for enabling a data service, and handover, according to the operation instruction for enabling a data service, a first network currently used by the terminal to a second network.

When the user needs to perform a PS service, a data service of the terminal may be disabled by means of a touch operation or a click operation. When receiving the operation instruction, from the user, for disabling a data service, the terminal hands over from the originally used first network (such as a network of a 2G/3G network standard) to the second network (such as a network of an LTE network standard).

The handing over a network currently used by the terminal to a second network specifically includes: sending a RAU request to the network side device of the second network; and after the network side device receives the routing area update request, reselecting and camping on an idle-state cell of the second network, so that the terminal hands over back to the second network through reselection.

It should be noted that because the terminal sets the network standard supported by the terminal itself to the second network, which indicates that the terminal already has an LTE capability, after activating a PDP context, the terminal sends the routing area update (RAU) request to notify the network side of the information indicating that the terminal supports the LTE network, and after the network side receives the routing area update request, the terminal reselects an idle-state cell and hands over back to the LTE network. Both the routing area update and the idle-state cell reselection belong to the prior art. This embodiment of the present invention does not specifically limit the processes, and details are not described herein.

If the terminal currently is not located within coverage of the LTE network, the terminal cannot camp on the LTE network through selection, that is, the terminal cannot hand over to the second network, and at this time, the terminal may still camp on a UMTS network or a GSM network. However, when the terminal moves to the coverage of the LTE network, the terminal hands over to the LTE network through reselection.

In this embodiment of the present invention, a terminal receives an operation instruction for disabling a data service, and hands over, according to the operation instruction for disabling a data service, a second network currently used by the terminal to a first network; or receives an operation instruction for enabling a data service, and hands over, according to the operation instruction for enabling a data service, a first network currently used by the terminal to a second network, where a network standard of the first network is a UMTS network standard or a GSM network standard, and a network standard of the second network is an LTE network standard. Therefore, in the present invention, when UE disables a data service and does not use a high-speed data network, an automatic handover to the first network is performed and the terminal may use a service provided by the first network. When the UE needs to perform a packet switched data service, a handover of a network standard to the second network is performed, so that the terminal hands over between the first network and the second network, thereby reducing network resources of the high-speed data network.

Correspondingly, the present invention further provides a terminal. FIG. 2 is a schematic diagram of a terminal according to an embodiment of the present invention. As shown in FIG. 2, the terminal provided by this embodiment includes a receiving unit 201, and a first handover unit 202 or a second handover unit 203.

The receiving unit 201 is configured to receive an operation instruction for disabling a data service.

The first handover unit 202 is configured to hand over, according to the operation instruction for disabling a data service, a second network currently used by the terminal to a first network.

A process of handing over, by the first handover unit 202, a second network currently used by the terminal to a first network is specifically: sending a detach Detach request to a network side device of the second network, so that the terminal is detached from the second network; and sending an attach Attach request to a network side device of the first network, so that the terminal is attached to the first network.

A network standard of the second network may be an LTE network standard, and a network standard of the first network may be a GSM network standard or a UMTS network standard.

The terminal provided by this embodiment of the present invention further includes: an attaching unit 204, where the attaching unit is configured to attach the terminal to the second network. The attaching unit 204 can ensure that after a mobile terminal is turned on in an area covered by LTE, the mobile terminal performs network selection and camps on an LTE network.

When receiving the operation instruction, from a user, for disabling a data service, the terminal first performs an operation of deactivating adeactivating adeactivating a PDP context, so as to release LTE wireless resources. After releasing the LTE wireless resources, the terminal hands over from the originally used second network (such as a network of an LTE network standard) to the first network (such as a network of a 2G/3G network standard).

When the user does not need a high-speed data service, the first handover unit 201 may disable the data service, and automatically hand over to a 2G/3G network. In this way, the terminal may use a CS service provided by the 2G/3G network. When the terminal receives a voice call during this period, the terminal may enjoy call connection experience that is the same as that of 2G and 3G networks. Generally, a user of a smart terminal disables a data service when the user does not use the data service. Therefore, this operation can effectively improve the call connection experience.

The receiving unit 201 is further configured to receive an operation instruction for enabling a data service.

The second handover unit 203 is configured to hand over, according to the operation instruction for enabling a data service, a first network currently used by the terminal to a second network.

A process of handing over, by the second handover unit 203, a first network currently used by the terminal to a second network is specifically: sending a RAU request to the network side device of the second network; and after the network side device receives the routing area update request, reselecting and camping on an idle-state cell of the second network, so that the terminal hands over back to the second network through reselection.

When the user needs to perform a PS service, a data service of the terminal may be disabled by means of a touch operation or a click operation. When receiving the operation instruction, from the user, for disabling a data service, the terminal hands over from the originally used first network (such as a network of a 2G/3G network standard) to the second network (such as a network of an LTE network standard).

It should be noted that because the terminal sets the network standard supported by the terminal itself to the second network, which indicates that the terminal already has an LTE capability, after activating a PDP context, the terminal sends the routing area update (RAU) request to notify the network side of the information indicating that the terminal supports the LTE network, and after the network side receives the routing area update request, the terminal reselects an idle-state cell and hands over back to the LTE network. Both the routing area update and the idle-state cell reselection belong to the prior art. This embodiment of the present invention does not specifically limit the processes, and details are not described herein.

If the terminal currently is not located within coverage of the LTE network, the terminal cannot camp on the LTE network through selection, that is, the terminal cannot hand over to the second network, and at this time, the terminal may still camp on a UMTS network or a GSM network. However, when the terminal moves to the coverage of the LTE network, the terminal hands over to the LTE network through reselection.

In this embodiment of the present invention, the terminal receives an operation instruction for disabling a data service, and hands over, according to the operation instruction for disabling a data service, a second network currently used by the terminal to a first network; or receives an operation instruction for enabling a data service, and hands over, according to the operation instruction for enabling a data service, a first network currently used by the terminal to a second network, where a network standard of the first network is a UMTS network standard or a GSM network standard, and a network standard of the second network is an LTE network standard. Therefore, in the present invention, when UE disables a data service and does not use a high-speed data network, an automatic handover to the first network is performed and the terminal may use a service provided by the first network. When the UE needs to perform a packet switched data service, a handover of a network standard to the second network is performed, so that the terminal hands over between the first network and the second network, thereby reducing network resources of the high-speed data network.

Correspondingly, an embodiment of the present invention further provides a terminal. FIG. 3 is a schematic diagram of another terminal according to this embodiment of the present invention. As shown in FIG. 3, the terminal provided by this embodiment includes a network interface 301 and a processor 302, and the network interface 301 and the processor 302 are connected by using a bus 303. The terminal further includes a memory 304, configured to store program code and transmit the program code to the processor. The memory may include a volatile memory, a non-volatile memory, a hard disk, or the like; and the memory may also include a combination of the foregoing types of memories. The memory 304 is connected to the processor and the network interface by using the bus 303,

where

the network interface 301 is configured to receive an operation instruction for disabling a data service; and

the processor 302 is configured to hand over, according to the operation instruction for disabling a data service, a second network currently used by the terminal to a first network; or

the network interface 301 is further configured to receive an operation instruction for enabling a data service; and

the processor 302 is configured to hand over, according to the operation instruction for enabling a data service, a first network currently used by the terminal to a second network, where

a network standard of the first network is a UMTS network standard or a GSM network standard, and a network standard of the second network is an LTE network standard.

Further, before the network interface 301 receives the operation instruction for disabling a data service, the processor 302 is further configured to attach the terminal to the second network.

Further, a process of handing over, by the processor 302 processor, a second network currently used by the terminal to a first network specifically includes: sending a detach Detach request to a network side device of the second network, so that the terminal is detached from the second network; and sending an attach Attach request to a network side device of the first network, so that the terminal is attached to the first network.

Further, the handing over, by the processor 302 processor, a first network currently used by the terminal to a second network specifically includes: sending a routing area update RAU request to the network side device of the second network; and after the network side device receives the routing area update request, reselecting and camping on an idle-state cell of the second network, so that the terminal hands over back to the second network through reselection.

Therefore, in the present invention, when UE disables a data service and does not use a high-speed data network, an automatic handover to a first network is performed and the terminal may use a service provided by the first network. When the UE needs to perform a packet switched data service, a handover of a network standard to a second network is performed, so that the terminal hands over between the first network and the second network, thereby reducing network resources of the high-speed data network.

A person in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementation manners, the objective, technical solutions, and benefits of the present invention are further described in detail. It should be understood that the foregoing descriptions are merely specific implementation manners of the present invention, but are not intended to limit the protection scope of the present invention. Any modification, equivalent replacement, or improvement made without departing from the spirit and principle of the present invention should fall within the protection scope of the present invention.

1-12. (canceled)

13. A network handover method, applied to a terminal, wherein the method comprises:
receiving an operation instruction for disabling a data service; and
handing over, according to the operation instruction for disabling a data service, a second network currently used by the terminal to a first network; or
handing over, according to the operation instruction for enabling a data service, a first network currently used by the terminal to a second network, wherein
a network standard of the first network is a Universal Mobile Telecommunications System (UMTS) network standard or a Global System for Mobile Communications (GSM) network standard, and a network standard of the second network is a Long Term Evolution (LTE) network standard.

14. The handover method according to claim 13, wherein before the receiving an operation instruction for disabling a data service, the method further comprises: attaching the terminal to the second network.

15. The handover method according to claim 13, wherein the handing over a second network currently used by the terminal to a first network comprises: sending a detach request to a network side device of the second network, so that the terminal is detached from the second network; and sending an attach request to a network side device of the first network, so that the terminal is attached to the first network.

16. The handover method according to claim 13, wherein the handing over a first network currently used by the terminal to a second network comprises: sending a routing area update (RAU) request to the network side device of the second network; and after the network side device receives the routing area update request, reselecting and camping on an idle-state cell of the second network, so that the terminal hands over back to the second network through reselection.

17. A terminal comprising a receiving unit, and a first handover unit or a second handover unit, wherein
the receiving unit is configured to receive an operation instruction for disabling a data service; and
the first handover unit is configured to hand over, according to the operation instruction for disabling a data service, a second network currently used by the terminal to a first network; or
the second handover unit is configured to hand over, according to the operation instruction for enabling a data service, a first network currently used by the terminal to a second network, wherein
a network standard of the first network is a Universal Mobile Telecommunications System (UMTS) network standard or a Global System for Mobile Communications (GSM) network standard, and a network standard of the second network is a Long Term Evolution (LTE) network standard.

18. The terminal according to claim 17, wherein the terminal further comprises: an attaching unit, configured to attach the terminal to the second network.

19. The terminal according to claim 17, wherein a process of handing over, by the first handover unit, a second network currently used by the terminal to a first network includes: sending a detach request to a network side device of the second network, so that the terminal is detached from the second network; and sending an attach request to a network side device of the first network, so that the terminal is attached to the first network.

20. The terminal according to claim 17, wherein a process of handing over, by the second handover unit, a first network currently used by the terminal to a second network includes: sending a routing area update RAU request to the network side device of the second network; and after the network side device receives the routing area update request, reselecting and camping on an idle-state cell of the second network, so that the terminal hands over back to the second network through reselection.

21. A terminal comprising a network interface and a processor, and the network interface and the processor are connected by a bus, wherein
the network interface is configured to receive an operation instruction for disabling a data service; and
the processor is configured to hand over, according to the operation instruction for disabling a data service, a second network currently used by the terminal to a first network; or
the processor is configured to hand over, according to the operation instruction for enabling a data service, a first network currently used by the terminal to a second network, wherein
a network standard of the first network is a Universal Mobile Telecommunications System (UMTS) network standard or a Global System for Mobile Communications (GSM) network standard, and a network standard of the second network is a Long Term Evolution (LTE) network standard.

22. The terminal according to claim 21, wherein before the network interface receives the operation instruction for disabling a data service, the processor is further configured to attach the terminal to the second network.

23. The terminal according to claim 21, wherein the handing over, by the processor, a second network currently used by the terminal to a first network comprises: sending a detach request to a network side device of the second network, so that the terminal is detached from the second network; and sending an attach request to a network side device of the first network, so that the terminal is attached to the first network.

24. The terminal according to claim 21, wherein the handing over, by the processor, a first network currently used by the terminal to a second network comprises: sending a routing area update RAU request to the network side device of the second network; and after the network side device receives the routing area update request, reselecting and camping on an idle-state cell of the second network, so that the terminal hands over back to the second network through reselection.
